(19) United States
(12) Patent Application Publication
(10) Pub. No.: US 2014/0303929 A1
(43) Pub. Date: Oct. 9, 2014

(54) METHOD TO OBTAIN ACCURATE VERTICAL COMPONENT ESTIMATES IN 3D POSITIONING

(71) Applicant: UMM AL-QURA UNIVERSITY, Makkah (SA)

(72) Inventor: MOHAMED KHALAF-ALLAH, MAKKAH (SA)

(73) Assignee: UMM AL-QURA UNIVERSITY, Makkah (SA)

(21) Appl. No.: 13/856,415

(22) Filed: Apr. 3, 2013

(51) Int. Cl. G01B 21/04

(52) U.S. Cl. CPC G01B 21/04
USPC 702/152

(57) ABSTRACT

The method to obtain accurate vertical component estimates in 3D positioning provides a closed-form least-squares solution based on time-difference of arrival (TDOA) measurements for the three-dimensional source location problem. The method provides an extension of an existing closed-form algorithm. The method utilizes the full set of the available TDOA measurements to increase the number of nuisance parameters. These nuisance parameters are range estimates from the source to the sensors, which the method uses for delivering accurate estimates of the vertical component of the source's location, even when quasi-coplanar sensors are employed.

### BACKGROUND OF THE INVENTION

1. Field of the Invention

The present invention relates to radiation source locators, and particularly to a method to obtain accurate vertical component estimates in 3D positioning of a radiation source.

2. Description of the Related Art

Determining the location of a target or radiating source from time difference of arrival (TDOA) measurements using sensor arrays has long been and is still of great research interest in many applications, where the position fix is computed from a set of intersecting hyperbolic curves generated by the TDOA measurements. The TDOA-based location estimation approach is widely implemented in, e.g. sensor and wireless communication networks, acoustics or microphone arrays, radar, sonar and seismic applications. When the location algorithm assumes an additive measurement error model, the available approaches include the maximum likelihood (ML) and the least-squares (LS). These approaches are implemented as iterative or non-iterative (closed-form) algorithms. LS based methods make no additional assumptions about the distribution of measurement errors. Therefore, most implementations exploit the LS principle. Moreover, LS techniques can produce closed-form solutions, which are favorable in an increasing range of applications.

The total number of TDOA measurements (equations) that can be generated using N sensors is N(N−1)/2, and is referred to as the full set (FS) measurements. If only measurements w.r.t. a single reference (master) sensor are considered, they are referred to as single set (SS) measurements, and their total number is given as N−1. SS measurements can deliver identical accuracies to the FS measurements, depending upon the geometry of the situation, in the case of normally distributed measurement errors.

Almost all algorithms available in the literature consider only SS measurements, and a few of them consider the SS and extra available measurements, referred to as extended SS (ExSS) measurements, such as the closed-form solution of hyperbolic geolocation. However, to the best of the inventor's knowledge, algorithms that can exploit the available FS of measurements are not common in the literature.

Closed-form (analytical) solutions are desirable because they usually have less computational loads than ML approaches or iterative methods, which need a good initial position estimate in order to avoid convergence to a local minimum. Furthermore, closed-form solutions do not require an initial position estimate to run, achieve estimation accuracies at acceptable levels, and are mathematically simple, robust and easy to implement for practical real-time applications, where low computational time and memory storage requirements are of high priority to meet imposed power constraints.

Known closed-form unconstrained and constrained LS solutions using a SS of the TDOA measurements are called single-set least-squares (SSLS) solutions. Other known closed-form SSLS solutions are called spherical interpolation (SI) and linear-correction least-squares (LCLS), respectively. Both the SI and LCLS methods require range measurements, which may not be available or may not be accurate enough due to clock synchronization errors, and are respectively equivalent to known unconstrained SSLS and constrained SSLS solutions, which depend only on TDOA measurements.

Thus, a method to obtain accurate vertical component estimates in 3D positioning is desired.

### SUMMARY OF THE INVENTION

The method to obtain accurate vertical component estimates in 3D positioning provides a closed-form least-squares solution based on time-difference of arrival (TDOA) measurements for the three-dimensional source location problem. The method provides an extension of an existing closed-form algorithm. The method utilizes the full set of the available TDOA measurements to increase the number of nuisance parameters. These nuisance parameters are range estimates from the source to the sensors, which the method uses for delivering accurate estimates of the vertical component of the source's location, even when quasi-coplanar sensors are employed.

These and other features of the present invention will become readily apparent upon further review of the following specification and drawings.

### BRIEF DESCRIPTION OF THE DRAWINGS

FIG. 1 is a plot showing Horizontal geometry of the sensors and source.

FIG. 2 is a plot showing Horizontal accuracies of the SSLS and FSLS estimators.

FIG. 3 is a plot showing Vertical accuracies of the SSLS solution and FSLS solution without using Equation (13) against the FSLS solution after using Equation (13).

Similar reference characters denote corresponding features consistently throughout the attached drawings.

### DETAILED DESCRIPTION OF THE PREFERRED EMBODIMENTS

At the outset, it should be understood by one of ordinary skill in the art that embodiments of the present method can comprise software or firmware code executing on a computer, a microcontroller, a microprocessor, or a DSP processor; state machines implemented in application specific or programmable logic; or numerous other forms without departing from the spirit and scope of the method described herein. The present method can be provided as a computer program, which includes a non-transitory machine-readable medium having stored thereon instructions that can be used to program a computer (or other electronic devices) to perform a process according to the method. The machine-readable medium can include, but is not limited to, floppy diskettes, optical disks, CD-ROMs, and magneto-optical disks, ROMs, RAMs, EPROMs, EEPROMs, magnetic or optical cards, flash memory, or other type of media or machine-readable medium suitable for storing electronic instructions.

Throughout this document, the term “least-squares estimation” may be abbreviated as (LSE). The term “time difference of arrival” may be abbreviated as (TDOA).

The method to obtain accurate vertical component estimates in 3D positioning provides a closed-form least-squares solution based on time-difference of arrival (TDOA) measurements for the three-dimensional source location problem. The method provides an extension of an existing closed-form algorithm. The method utilizes the full set of the available TDOA measurements to increase the number of nuisance parameters. These nuisance parameters are range estimates from the source to the sensors, which the method uses for delivering accurate estimates of the vertical component of the source's location, even when quasi-coplanar sensors are employed.

The present method exploits the knowledge about nuisance parameters to decrease the error in estimating the vertical component of a source's location in case the involved sensors are quasi-coplanar. The closed-form single set least squares (SSLS) algorithm in the prior art delivers the value of one nuisance parameter, which is the range from the source to the reference sensor. The present method extends this algorithm to include the full set TDOA measurements into a full set least-squares (FSLS) solution. Accordingly, the number of nuisance parameters increases to N−1. The advantages and usefulness of knowing the nuisance parameters is confirmed by obtaining more accurate estimates of the source's height in bad sensors' geometry.

Consider an array of N sensors located at known positions aᵢ=[xᵢ, yᵢ, zᵢ], in a 3-D Cartesian coordinate system, where i=1, . . . , N, observing signals from a radiating source located at an unknown position aₛ=[xₛ, yₛ, zₛ]. The TDOA of the source's signal measured at any sensor pairs i and j (denoted by τᵢⱼ, where i≠j) is related to the range difference (denoted by dᵢⱼ) by the relation dᵢⱼ=c·τᵢⱼ, where c is the known propagation speed of the signal in the medium. Thus, dᵢⱼ is expressed in the error-free case as:

dᵢⱼ=∥aⱼ−aₛ∥=∥aᵢ−aₛ∥, i=1, . . . , N, j=1, . . . , N, i≠j, (1)

where ∥•∥ denotes the Euclidean vector norm. From (1), the following relation is obtained:

∥aⱼ−aₛ∥²=[dᵢⱼ+∥aᵢ−aₛ∥]². (2)

With straightforward algebra, expression (2) yields:

$${d}_{ij} ‖ {a}_{i} - {a}_{s} ‖ + {[ {a}_{j} - {a}_{i} ]}^{T} \cdot {a}_{s} = \frac{[ {‖ {a}_{j} ‖}^{2} - {‖ {a}_{i} ‖}^{2} - {d}_{ij}^{2} ]}{2} . \qquad ( 3 )$$

The problem, thus, is to estimate the vector given a set of dᵢⱼ, i.e., τᵢⱼ noisy measurements, and using the known vectors aᵢ, which, in turn, might contain uncertainties.

Regarding a closed-form unconstrained single set least-squares (SSLS) estimator, without loss of generality, the first sensor can be considered as the reference sensor, and thus (3) is rewritten as:

dᵢⱼ∥a₁−aₛ∥+[aⱼ−a₁]^{T}·aₛ=b₁ⱼ, j=2, . . . , N, (4)

where b₁ⱼ=[∥aⱼ∥²−∥a₁∥²−d₁ⱼ²]/2. Equation (4) can be expressed in matrix form as:

$$\begin{matrix}Hs = b \\ where & ( 5 ) \\ H = [ \begin{matrix}{d}_{12} & {[ {a}_{2} - {a}_{1} ]}^{T} \\ {d}_{13} & {[ {a}_{3} - {a}_{1} ]}^{T} \\ \begin{matrix}⋮ \\ ⋮\end{matrix} & \begin{matrix}⋮ \\ ⋮\end{matrix} \\ {d}_{1 N} & {[ {a}_{N} - {a}_{1} ]}^{T}\end{matrix} ] , b = [ \begin{matrix}{b}_{12} \\ {b}_{13} \\ \begin{matrix}⋮ \\ ⋮\end{matrix} \\ {b}_{1 N}\end{matrix} ] , s = [ \begin{matrix}‖ {a}_{1} - {a}_{s} ‖ \\ {a}_{s}\end{matrix} ] . & ( 6 )\end{matrix}$$

Note that H is an (N−1)−4 matrix, b is an (N−1)×1 vector and s is a 4×1 vector, where the range ∥a₁−aₛ∥ to the reference sensor is a nuisance parameter. The unconstrained least-squares estimation of s reads:

\hat{s}=(H^{T}H)⁻¹H^{T}b. (7)

The corresponding estimate of aₛ is given as

âₛ=[0 1 1 1]ŝ. (8)

The 4×1 vector s is originally estimated. Therefore, at least four independent TDOA measurements with respect to a common reference sensor are needed. That is, at least five sensors are required in order to obtain a 3-D closed-form solution, i.e., Nₘᵢₙ=5.

Regarding the closed-form unconstrained full set least-squares (FSLS) estimator, the set of measurement equations available in the SS case are given in (4). Accordingly, the set of measurement equations available in the FS case can be straightforwardly written as:

$${d}_{1 j} ‖ {a}_{1} - {a}_{s} ‖ + {[ {a}_{j} - {a}_{1} ]}^{T} \cdot {a}_{s} = {b}_{1 j} , j = 2 , … , N \\ {d}_{2 j} ‖ {a}_{2} - {a}_{s} ‖ + {[ {a}_{j} - {a}_{2} ]}^{T} \cdot {a}_{s} = {b}_{2 j} , j = 3 , … , N \\ \begin{matrix}⋮ \\ ⋮\end{matrix} \\ {d}_{N - 1 , N} ‖ {a}_{N - 1} - {a}_{s} ‖ + {[ {a}_{N} - {a}_{N - 1} ]}^{T} \cdot {a}_{s} = {b}_{N - 1 , N} , \qquad ( 9 )$$

where, also without loss of generality, the first, second, . . . , (N−1) sensors have been considered sequentially as reference sensors, and the range difference measurements dᵢⱼ=−dⱼᵢ were considered only once. Expression (9) can also be written in matrix form as in (5), where the terms of this matrix form read:

$$\begin{matrix}H = [ \begin{matrix}{d}_{12} & 0 & 0 & … & … & {[ {a}_{2} - {a}_{1} ]}^{T} \\ {d}_{13} & 0 & 0 & … & … & {[ {a}_{3} - {a}_{1} ]}^{T} \\ ⋮ & ⋮ & ⋮ & ⋮ & ⋮ & ⋮ \\ ⋮ & ⋮ & ⋮ & ⋮ & ⋮ & ⋮ \\ {d}_{1 N} & 0 & 0 & … & … & {[ {a}_{N} - {a}_{1} ]}^{T} \\ 0 & {d}_{23} & 0 & … & … & {[ {a}_{3} - {a}_{2} ]}^{T} \\ 0 & {d}_{24} & 0 & … & … & {[ {a}_{4} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ 0 & {d}_{2 N} & 0 & … & … & {[ {a}_{N} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ ⋮ & ⋮ & ⋮ & ⋮ & ⋮ & ⋮ \\ 0 & … & … & 0 & {d}_{N - 1 , N} & {[ {a}_{N} - {a}_{N - 1} ]}^{T}\end{matrix} ] , & ( 10 ) \\ b = [ \begin{matrix}{b}_{12} \\ {b}_{13} \\ ⋮ \\ ⋮ \\ {b}_{1 N} \\ {b}_{23} \\ {b}_{24} \\ ⋮ \\ ⋮ \\ {b}_{2 N} \\ ⋮ \\ ⋮ \\ ⋮ \\ {b}_{N - 1 , N}\end{matrix} ] , s = [ \begin{matrix}‖ {a}_{1} - {a}_{s} ‖ \\ ‖ {a}_{2} - {a}_{s} ‖ \\ ⋮ \\ ⋮ \\ ‖ {a}_{N - 1} - {a}_{s} ‖ \\ {a}_{s}\end{matrix} ] . & \end{matrix}$$

The matrix H has a dimension of

$$\frac{N ( N - 1 )}{2} \times ( N + 2 ) ,$$

b is

$$\frac{N ( N - 1 )}{2} \times 1$$

an vector and s is an (N+2)×1 vector. The unconstrained least-squares estimation of aₛ thus reads:

aₛ=[0 0 . . . 0 1 1 1]ŝ. (11)

Note that the number of nuisance parameters in the (N+2)×1 vector s given in (10) has increased to (N−1) parameters or ranges to all sensors that acted as references.

The estimates of these nuisance parameters are utilized in order to increase the estimation accuracy of the source's height, i.e., the vertical component of the source's position, zₛ.

After the usual solution in (11), the horizontal (xₛ, yₛ) accuracy will be satisfactory, but the error in the source's height estimation zₛ will be large in the case of quasi-coplanar placement of sensors. The accurate horizontal estimation of the source's position can be used to obtain accurate 2D range estimates \sqrt{(xᵢ−xₛ)²+(yᵢ−yₛ)²} from source to sensors. Estimates for the height (vertical) difference h between the source and the sensors are obtained from the 3D range estimates (nuisance parameters) and the 2D range estimates. Now hₘᵢₙ between the source and a sensor called best sensor is obtained. Therefore, minimization is performed as follows:

$$\begin{matrix}min \\ i = 1 , … , N - 1\end{matrix} ( {‖ {a}_{i} - {a}_{s} ‖}^{2} - ( {( {x}_{i} - {x}_{s} )}^{2} + {( {y}_{i} - {y}_{s} )}^{2} ) = {h}_{m i n}^{2} \qquad ( 12 )$$

Finally, the estimation of the vertical component of the source's position is improved by adding this minimum height difference hₘᵢₙ to, or subtracting it from, the known vertical position of the best sensor, depending on the placement of this best sensor's horizontal plane relative to the source's horizontal plane, as:

\hat{Z}_{S=}z_{best}_{_{—}}ₛₑₙₛₒᵣ±hₘᵢₙ. (13)

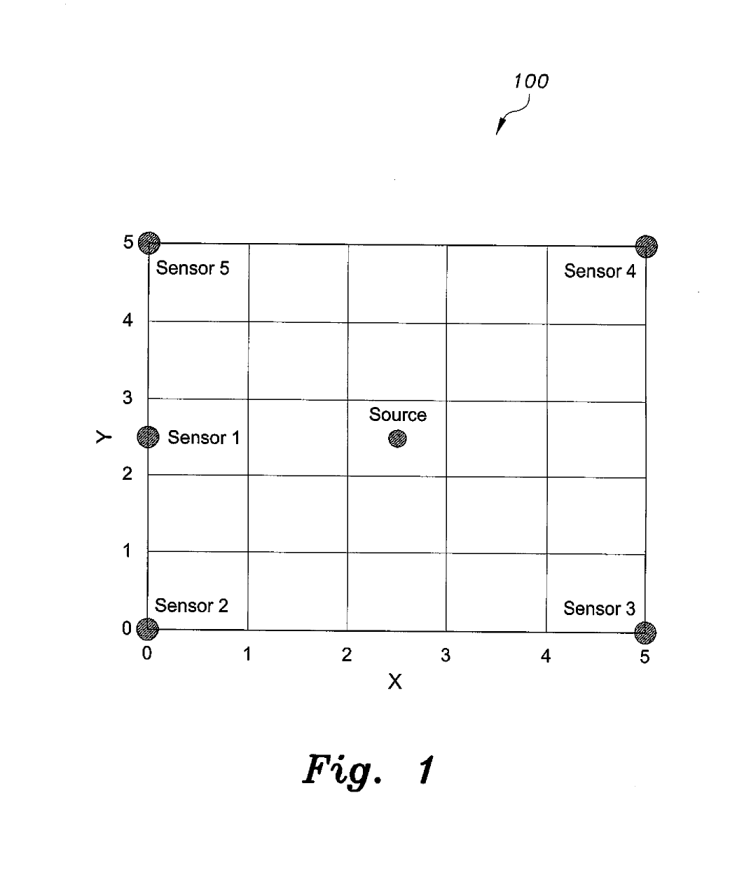

Five fixed sensors and a fixed source were located in a 5×5 m² area at (0,2.5,1), (0,0,1.1), (5,0,1), (5,5,1.1), (0,5,1), and (2.5,2.5,1.5), respectively, as shown in FIG. 1. Three sensors are placed at a height of 1 meter and two at a height of 1.1 meters, so that the geometry for accurate height estimation is really bad. Sensor 1 is considered the reference for the single set (SS) solution. Due to the symmetrical position of sensor 1, the accuracies of the SS solution and full set (FS) solution without refining the estimation of the vertical component will be identical in this case. SS and FS measurements were collected from 10,000 independent simulation runs (epochs), where the measurement errors were assumed to be normally distributed with a variance of 0.1 m.

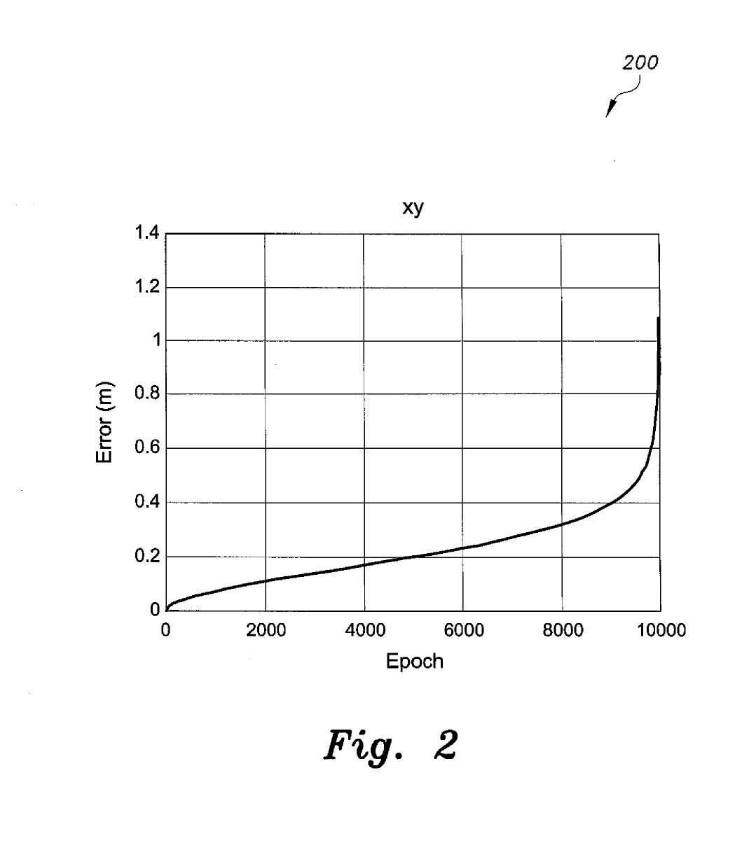

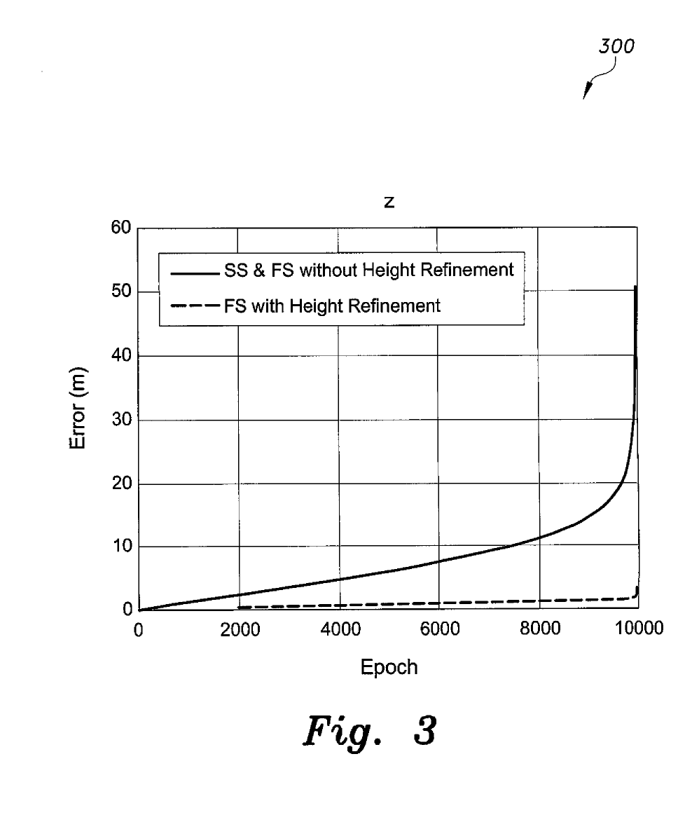

FIG. 2 shows the horizontal accuracies of the SSLS and FSLS estimators, which are identical, as mentioned before. The 67% and the 95% horizontal errors were 26 cm and 47 cm, respectively. FIG. 3 compares the vertical accuracies obtained by the SSLS solution and FSLS solution without using Equation (13) against the FSLS solution after using Equation (13). In the first case, the 67% and 95% vertical errors were 8.5 m and 17.8 m, respectively. After utilization of the nuisance parameters' or ranges' estimates, as described above, the 67% and 95% vertical errors were dramatically reduced to 0.88 m and 1.33 m, respectively.

It is to be understood that the present invention is not limited to the embodiments described above, but encompasses any and all embodiments within the scope of the following claims.

I claim:

1. A computer-implemented method to obtain accurate vertical component estimates in 3D positioning of a radiating source, comprising the steps of:
using known locations of an array of N sensors, N≧5, in a 3-D Cartesian coordinate system;
using the array of sensors to observe time difference of arrival (TDOA) signals from a radiating source located at an unknown position in the 3-D Cartesian coordinate system;
iteratively using a single sensor of the sensor array as a reference sensor during the s time difference of arrival observation, thereby assisting determination of a Euclidian vector estimating the 3-D position of the radiating source;
extracting nuisance parameter 3-D range estimates from the TDOA observation, the nuisance parameter 3-D range estimates being used to increase estimation accuracy of the radiating source's height;
determining a best sensor of the sensor array based on comparative measurements of the iteratively used reference sensor;
determining a minimum height difference between the radiating source and the best sensor of the sensor array; and
adjusting a known vertical position of the best sensor by the minimum height difference, thereby improving accuracy of estimation of the radiating source's height.

2. The computer-implemented method to obtain accurate vertical component estimates in 3D positioning according to claim 1, wherein said observations comprise computing a set of measurements characterized by the relation:
$${d}_{1 j} ‖ {a}_{1} - {a}_{s} ‖ + {[ {a}_{j} - {a}_{1} ]}^{T} \cdot {a}_{s} = {b}_{1 j} , j = 2 , … , N$$
$${d}_{2 j} ‖ {a}_{2} - {a}_{s} ‖ + {[ {a}_{j} - {a}_{2} ]}^{T} \cdot {a}_{s} = {b}_{2 j} , j = 3 , … , N$$
$$⋮$$
$${d}_{N - 1 , N} ‖ {a}_{N - 1} - {a}_{s} ‖ + {[ {a}_{N} - {a}_{N - 1} ]}^{T} \cdot {a}_{s} = {b}_{N - 1 , N} ,$$
further characterized by the relation:
$$\begin{matrix}H = [ \begin{matrix}{d}_{12} & 0 & 0 & … & … & {[ {a}_{2} - {a}_{1} ]}^{T} \\ {d}_{13} & 0 & 0 & … & … & {[ {a}_{3} - {a}_{1} ]}^{T} \\ ⋮ & ⋮ & ⋮ & ⋮ & ⋮ & ⋮ \\ ⋮ & ⋮ & ⋮ & ⋮ & ⋮ & ⋮ \\ {d}_{1 N} & 0 & 0 & … & … & {[ {a}_{N} - {a}_{1} ]}^{T} \\ 0 & {d}_{23} & 0 & … & … & {[ {a}_{3} - {a}_{2} ]}^{T} \\ 0 & {d}_{24} & 0 & … & … & {[ {a}_{4} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ 0 & {d}_{2 N} & 0 & … & … & {[ {a}_{N} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ ⋮ & ⋮ & ⋮ & ⋮ & ⋮ & ⋮ \\ 0 & … & … & 0 & {d}_{N - 1 , N} & {[ {a}_{N} - {a}_{N - 1} ]}^{T}\end{matrix} ] , \\ b = [ \begin{matrix}{b}_{12} \\ {b}_{13} \\ ⋮ \\ ⋮ \\ {b}_{1 N} \\ {b}_{23} \\ {b}_{24} \\ ⋮ \\ ⋮ \\ {b}_{2 N} \\ ⋮ \\ ⋮ \\ ⋮ \\ {b}_{N - 1 , N}\end{matrix} ] , s = [ \begin{matrix}‖ {a}_{1} - {a}_{s} ‖ \\ ‖ {a}_{2} - {a}_{s} ‖ \\ ⋮ \\ ⋮ \\ ‖ {a}_{N - 1} - {a}_{s} ‖ \\ {a}_{s}\end{matrix} ] .\end{matrix}$$
wherein an unconstrained least-squares estimation of aₛ is characterized by the relation:
aₛ=[0 0 . . . 0 1 1 1]ŝ,
which describes the nuisance parameters of the measurements, where d is the set of measurements, aᵢ, i=1, . . . , N, are known vectors, H is an (N−1)×4 matrix, b is an (N−1)×1 vector, and s is a 4×1 vector, where the ranges ∥aᵢ−aₛ∥, i=1, . . . , N−1, are nuisance parameters.

3. The computer-implemented method to obtain accurate vertical component estimates in 3D positioning according to claim 2, wherein said minimum height determination step further comprises performing an intermediate computation according to the relation:
$$\begin{matrix}min \\ i = 1 , … , N - 1\end{matrix} ( {‖ {a}_{i} - {a}_{s} ‖}^{2} - ( {( {x}_{i} - {x}_{s} )}^{2} + {( {y}_{i} - {y}_{s} )}^{2} ) = {h}_{m i n}^{2} .$$

4. The computer-implemented method to obtain accurate vertical component estimates in 3D positioning according to claim 3, wherein said best sensor known vertical position adjustment step comprises a final calculation according to the relation:
\hat{z}ₛ=z_{best}_{_{—}}ₛₑₙₛₒᵣ±hₘᵢₙ,
where hₘᵢₙ is said minimum height difference.

5. A computer software product, comprising a non-transitory medium readable by a processor, the non-transitory medium having stored thereon a set of instructions for performing a method to obtain accurate vertical component estimates in 3D positioning of a radiating source, the set of instructions including:
(a) a first sequence of instructions which, when executed by the processor, causes said processor to use known locations of an array of N sensors, N≧5, in a 3-D Cartesian coordinate system;
(b) a second sequence of instructions which, when executed by the processor, causes said processor to use said array of sensors to observe time difference of arrival (TDOA) signals from a radiating source located at an unknown position in said 3-D Cartesian coordinate system;
(c) a third sequence of instructions which, when executed by the processor, causes said processor to iteratively use a single sensor of said sensor array as a reference sensor during said time difference of arrival observation thereby assisting determination of a Euclidian vector estimating the 3-D position of said radiating source;
(d) a fourth sequence of instructions which, when executed by the processor, causes said processor to extract nuisance parameter 3-D range estimates from said TDOA observation, said nuisance parameter 3-D range estimates being used to increase estimation accuracy of said radiating source's height;
(e) a fifth sequence of instructions which, when executed by the processor, causes said processor to determine a best sensor of said sensor array based on comparative measurements of said iteratively used reference sensor;
(f) a sixth sequence of instructions which, when executed by the processor, causes said processor to determine a minimum height difference between said radiating source and said best sensor of said sensor array; and
(g) a seventh sequence of instructions which, when executed by the processor, causes said processor to adjust a known vertical position of said best sensor by said minimum height difference thereby improving accuracy of measurement of said radiating source's height.

6. The computer product according to claim 5, wherein said observations comprise an eighth sequence of instructions which, when executed by the processor, causes said processor to compute a set of measurements characterized by the relation:
$${d}_{1 j} ‖ {a}_{1} - {a}_{s} ‖ + {[ {a}_{j} - {a}_{1} ]}^{T} \cdot {a}_{s} = {b}_{1 j} , j = 2 , … , N$$
$${d}_{2 j} ‖ {a}_{2} - {a}_{s} ‖ + {[ {a}_{j} - {a}_{2} ]}^{T} \cdot {a}_{s} = {b}_{2 j} , j = 3 , … , N$$
$$\begin{matrix}⋮ \\ ⋮\end{matrix}$$
$${d}_{N - 1 , N} ‖ {a}_{N - 1} - {a}_{s} ‖ + {[ {a}_{N} - {a}_{N - 1} ]}^{T} \cdot {a}_{s} = {b}_{N - 1 , N} ,$$
further characterized by the relation:
$$\begin{matrix}H = [ \begin{matrix}{d}_{12} & 0 & 0 & … & … & {[ {a}_{2} - {a}_{1} ]}^{T} \\ {d}_{13} & 0 & 0 & … & … & {[ {a}_{3} - {a}_{1} ]}^{T} \\ ⋮ & ⋮ & ⋮ & ⋮ & ⋮ & ⋮ \\ ⋮ & ⋮ & ⋮ & ⋮ & ⋮ & ⋮ \\ {d}_{1 N} & 0 & 0 & … & … & {[ {a}_{N} - {a}_{1} ]}^{T} \\ 0 & {d}_{23} & 0 & … & … & {[ {a}_{3} - {a}_{2} ]}^{T} \\ 0 & {d}_{24} & 0 & … & … & {[ {a}_{4} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ 0 & {d}_{2 N} & 0 & … & … & {[ {a}_{N} - {a}_{2} ]}^{T} \\ ⋮ & ⋮ & ⋮ & ⋮ & ⋮ & ⋮ \\ ⋮ & ⋮ & ⋮ & ⋮ & ⋮ & ⋮ \\ ⋮ & ⋮ & ⋮ & ⋮ & ⋮ & ⋮ \\ 0 & … & … & 0 & {d}_{N - 1 , N} & {[ {a}_{N} - {a}_{N - 1} ]}^{T}\end{matrix} ] , \\ b = [ \begin{matrix}{b}_{12} \\ {b}_{13} \\ ⋮ \\ ⋮ \\ {b}_{1 N} \\ {b}_{23} \\ {b}_{24} \\ ⋮ \\ ⋮ \\ {b}_{2 N} \\ ⋮ \\ ⋮ \\ ⋮ \\ {b}_{N - 1 , N}\end{matrix} ] , s = [ \begin{matrix}‖ {a}_{1} - {a}_{s} ‖ \\ ‖ {a}_{2} - {a}_{s} ‖ \\ ⋮ \\ ⋮ \\ ‖ {a}_{N - 1} - {a}_{s} ‖ \\ {a}_{s}\end{matrix} ] .\end{matrix}$$
wherein an unconstrained least-squares estimation of aₛ is characterized by the relation:
aₛ=[0 0 . . . 0 1 1 1]ŝ,
which describes the nuisance parameters of the measurements, where d is the set of measurements, aᵢ, i=1, . . . , N, are known vectors, H is an (N−1)×4 matrix, b is an (N−1)×1 vector, and s is a 4×1 vector, where the ranges ∥aᵢ−aₛ∥, i=1, . . . , N−1, are nuisance parameters.

7. The computer product according to claim 6, further comprising a ninth sequence of instructions which, when executed by the processor, causes said processor to perform an intermediate minimum height determining computation according to the relation:
$$\begin{matrix}min \\ i = 1 , … , N - 1\end{matrix} ( {‖ {a}_{i} - {a}_{s} ‖}^{2} - ( {( {x}_{i} - {x}_{s} )}^{2} + {( {y}_{i} - {y}_{s} )}^{2} ) = {h}_{m i n}^{2} .$$

8. The computer product according to claim 7, further comprising a tenth sequence of instructions which, when executed by the processor, causes said processor to perform a final vertical position adjustment calculation according to the relation:
\hat{Z}ₛ=z_{best}_{_{—}}ₛₑₙₛₒᵣ±hₘᵢₙ,
where hₘᵢₙ is said minimum height difference.
